(19) United States
(12) Patent Application Publication
(10) Pub. No.: US 2025/0276808 A1
(43) Pub. Date: Sep. 4, 2025

(54) SUSTAINABLE AIRCRAFT FLOORPATH MARKING

(71) Applicant: STG Aerospace Limited, Cwmbran (GB)

(72) Inventors: Sean Patrick O'Kell, Cwmbran (GB); Andrew Jon Hallett, Cwmbran (GB); Tracy Suresh Vyas-Middlecoat, Cwmbran (GB)

(73) Assignee: STG Aerospace Limited, Cwmbran (GB)

(21) Appl. No.: 19/062,894

(22) Filed: Feb. 25, 2025

(30) Foreign Application Priority Data
Mar. 1, 2024 (GB) GB2403013.2
May 24, 2024 (GB) GB2407469.2

(51) Int. Cl. B64D 45/00; B41M 1/30; C09D 11/037

(52) U.S. Cl. CPC B64D 45/00; B41M 1/30; C09D 11/037; B64D 2045/007

(57) ABSTRACT

A method of manufacturing an aircraft emergency guidance assembly includes forming a photoluminescent layer on a substrate by printing an ink onto the substrate. The ink includes a water-based resin that forms at least 20% of the ink by mass and a photoluminescent material that forms at least 20% of the ink by mass.

### CROSS-REFERENCE TO RELATED PATENT APPLICATIONS

The present application claims the benefit of and priority to both United Kingdom Application No. GB2403013.2, filed Mar. 1, 2024, and United Kingdom Application No. GB2407469.2, filed May 24, 2024, the complete disclosures of both of which, including their specifications, drawings, claims and abstracts, are incorporated herein by reference in their entireties.

### BACKGROUND

This invention relates to aircraft emergency way guidance assemblies, to methods of making such aircraft emergency way guidance assemblies, and to improvements in such assemblies.

It known to provide photoluminescent (PL) floorpath marking assemblies in aircraft cabins. Such assemblies are typically fitted to a floor of the aircraft cabin. In many cases an assembly in the form of a track is provided along at least one side of an aisle. In most examples a track is provided along both sides of the aisle in order to guide and direct passengers in case of an emergency from their seats to an emergency exit. Aircraft emergency way guidance assemblies may also comprise tracks or other markers on or along other surfaces—e.g. cabin walls or even seats.

Known aircraft emergency way guidance designs—including products produced by the applicant—often have a photoluminescent insert encased within a polymeric housing such as an extruded polycarbonate sleeve or casing. Virgin polymers (i.e. newly-made/not recycled) are used to ensure compliance with strict aerospace standards, and—whilst these polymers are recyclable—in reality it has been found that they are often not recycled. This is in part due to additives and coatings (e.g. flame retardants) often required for compliance with aerospace requirements making the products potentially quite difficult to recycle even where there is a will to do so. A tough, highly transparent, polycarbonate (PC) plastic is often used, which is particularly harmful to the environment and can end up in landfill indefinitely. The carbon footprint associated with the production of 1 kg of polycarbonate is around 6 kg. Standard virgin PC also uses 100% fossil fuel derivatives for its production and does not include any recycled material. It will be appreciated that other polymers can also be used, e.g. polymethyl methacrylate (PMMA) and that similar environmental considerations apply. The insert generally comprises a photoluminescent material embedded within a resin. An organic solvent-based resin is generally used, with the resin then being dried and/or cured for use. The generation and use of organic solvents, and the release of these during the curing process, can have deleterious environmental effects. The resin itself may be deposited onto a polymeric substrate, e.g. by screen printing. A virgin polymer that meets aerospace requirements is again generally used, so having the same environmental issued as for the polymeric housing.

It is an object of the invention to provide a more sustainable aircraft emergency guidance assembly.

### SUMMARY

According to an exemplary embodiment, a method of manufacturing an aircraft emergency guidance assembly includes forming a photoluminescent layer on a substrate by printing an ink onto the substrate. The ink includes a water-based resin, wherein the water-based resin forms at least 20% of the ink by mass. The ink also includes a photoluminescent material having a median particle size, d50, in the range from 10 μm to 100 μm, wherein the photoluminescent material forms at least 20% of the ink by mass.

According to another exemplary embodiment, an aircraft emergency guidance assembly arranged to be mounted in an aircraft cabin includes a longitudinally extending photoluminescent layer, a substrate supporting the photoluminescent layer, and a housing arranged to protect the photoluminescent layer. The photoluminescent layer is made from a water-based resin having embedded therein a photoluminescent material having a median particle size, d50, in the range from 10 μm to 100 μm.

According to another exemplary embodiment, an aircraft includes an aircraft cabin comprising an aircraft emergency guidance assembly. The aircraft emergency guidance assembly includes a longitudinally extending photoluminescent layer, a substrate supporting the photoluminescent layer, and a housing arranged to protect the photoluminescent layer. The photoluminescent layer is made from a water-based resin having embedded therein a photoluminescent material having a median particle size, d50, in the range from 10 μm to 100 μm.

### BRIEF DESCRIPTION OF THE DRAWINGS

The invention will now be described by way of example only with reference to the following Figures in which:

FIG. 1 is a cross section of a portion of a photoluminescent layer and substrate in accordance with the invention;

FIG. 2 is a cross section of a portion of an alternative photoluminescent layer and substrate in accordance with the invention;

FIGS. 3A and 3B illustrate two different aircraft emergency guidance assemblies, each containing a photoluminescent layer;

FIG. 4 shows a method of making a photoluminescent layer in accordance with the invention;

FIG. 5 is a schematic of an aircraft in accordance with various aspects of the invention; and

FIG. 6 is a cross section of a portion of an alternative photoluminescent layer and substrate in accordance with the invention.

### DETAILED DESCRIPTION

According to a first aspect of the invention, there is provided a method of manufacturing an aircraft emergency guidance assembly, the method comprising forming a photoluminescent layer on a substrate by printing an ink onto the substrate. The ink comprises: a water-based resin, wherein the water-based resin forms at least 20% of the ink by mass; and a photoluminescent material, wherein the photoluminescent material forms at least 20% of the ink by mass.

The substrate may be polymeric.

The water-based resin may form at least 25% of the ink by mass, and optionally at least 30% or 35% of the ink by mass.

The water-based resin and the photoluminescent material together may form at least 80% of the ink by mass, and optionally at least 85% or 90% of the ink. The water-based resin and the photoluminescent material together may form 90-100% of the ink by mass, and optionally may form 91-95% of the ink by mass, with the remainder being a retarder and/or one or more other additives such as a wetting agent and/or emulsifier.

There has previously been a prejudice in the art against the use of water-based resins, as these are often milky in appearance once cured than organic solvent-based resins, so reducing light transmission. However, the inventors appreciated that careful control of ink properties (including loading of the photoluminescent material) and of ink layer thickness (which can be adjusted by controlling properties of the ink itself, as well as by controlling the printing process) can be used to mitigate this issue and form a product that still meets aerospace requirements, whilst offering improved environmental credentials.

Due to the chemical compositions of materials used and the surface interaction required to bond, water-based resins have not previously been used alongside polymer substrates for aircraft emergency guidance assembly-poor bonding between a water-based resin and a polymeric substrate was expected. The approach described herein has overcome this prejudice in the art to form a robust photoluminescent layer suitable for use in aircraft emergency guidance assemblies.

As a result of the use of a water-based resin to make the ink, there is a reduction in the amount of volatile organic compounds (VOCs) released during production, so making the method more environmentally-friendly than prior art approaches.

As used herein, “resin” takes the meaning of solid or liquid organic polymer product such as is used as the basis of various plastics, adhesives, varnishes, inks, paints, and similar. Whilst many resins rely on organic solvents, a water-based resin uses water as the primary, or only, solvent. It will be appreciated that the consistency of the ink may therefore be adjusted by adding additional water, thinning the resin (e.g. to make the consistency fluid enough for the chosen printing technique, e.g. screen printing), or indeed by removing water (e.g. to thicken the ink sufficiently that a desired layer thickness can be obtained by a single print).

The ink may comprise at least 50% photoluminescent material by mass, and optionally may comprise 60% photoluminescent material by mass.

The ink may comprise 20-75% photoluminescent material by mass, and optionally 25-75%, 30-75%, 40-75% or 50-75% photoluminescent material by mass.

The ink may comprise at least 3%, and optionally at least 4%, 5%, 8%, 10%, or 12%, water by mass, the water mass forming a part of the mass of the water-based resin. The ink may comprise between 4% and 25% water by mass, and optionally between 15% and 20% water by mass. A higher % water may be used to lower the ink's viscosity, which may facilitate printing. A better consistency for the ink may be achieved by thinning a resin to be used with additional water.

It will be appreciated that the water-based resin generally loses water (and possibly one or more other relatively volatile components or additives, where present) before completion of the photoluminescent layer, e.g. during drying and/or baking steps of the method, and even during the printing process, e.g. whilst the ink is on a screen of a screen-printer. The photoluminescent material loading by mass of the final photoluminescent layer is therefore generally higher than the photoluminescent material loading by mass of the ink. Percentages listed by mass of the ink are therefore for the “fresh” ink, e.g. on first opening a container of the ink.

The substrate may be a polymeric substrate, and optionally may comprise at least 20%, 30%, 40% or 50% recycled polymer by mass. The substrate may be a polymeric substrate comprising 80% recycled polymer by mass.

The method may comprise printing a plurality of layers of the same ink onto the substrate. The method may comprise printing a plurality of layers of different inks onto the substrate, each ink comprising a water-based resin which forms at least 20% (and optionally at least 25%) of the ink by mass; and a photoluminescent material which forms at least 30% of the ink by mass.

The method may comprise printing at least two layers of ink (optionally the same ink) onto the substrate so as to build up the photoluminescent layer. The method may comprise printing two, three, four, five, six, seven, eight, or nine layers of ink (optionally the same ink) onto the substrate so as to build up the photoluminescent layer. The method may comprise printing between three and eight layers of ink so as to build up the photoluminescent layer.

The printing method chosen may be screen-printing. Alternatively, any suitable printing technique known in the art may be used, for example a reel-to-reel printing process, such as reverse gravure coating, or a pad printing process.

In some embodiments, one or more layers of an ink, or other coating, without a PL component may be applied to the substrate before the ink with the PL component is applied; for example to provide an opaque (optionally white), reflective layer behind the photoluminescent layer. This may improve the appearance and/or luminance of the finished product. For example, two layers of an opaque white ink with a reflective finish once dried may be applied, followed by seven layers of the ink as described above to build up a PL layer on top of the white backing on the substrate. Numbers of layers, and/or colour of the backing ink, may vary in other embodiments.

The photoluminescent layer (optionally formed by multiple individual layers of the ink(s)) may have a thickness in the range from 200 to 450 μm, and optionally from 250 to 450 μm, and further optionally from 250 to 400 μm, or from 200 to 360 μm. The photoluminescent layer may have a thickness in the range 300-360 μm, or 350-400 μm. It will be appreciated that layer thickness is generally measured after the layer has dried/set/cured.

The photoluminescent material may have a carefully-selected particle size and particle size distribution-selections may be made based on a trade-off between brightness of the photoluminescent glow and duration of the photoluminescent glow (e.g. in terms of time period before the glow drops below a specified level, the specified level generally being based on aircraft safety regulations). The average (median) particle size, d₅₀, may be in the range from 10 μm to 100 μm, optionally from 15 μm to 50 μm, and further optionally from 20 μm to 45 μm. The average particle size (median, d₅₀) may be 25 μm, or 40 μm. For example, the material may have a d₅₀ of 25±5 μm, or of 40±5 μm. Narrower bounds may also be set, e.g. 25±4 μm.

The particle size distribution may be relatively narrow, for example such that at least 90% of the particles fall within a certain spread from the average (median) particle size.

Bounds may therefore be set on the d₉₀ for the photoluminescent material. For example, the material may have d₉₀≤115 μm or d₉₀≤60 μm, such that at least 90% of the particles have a particle size less than 115 μm or 60 μm, respectively. The d₉₀ of the material may be controlled to be no more than three times, and optionally no more than 2.5 times, the average particle size (d₅₀).

The photoluminescent material may have a median particle size, d₅₀, of X±5 μm or narrower, or a d₅₀ of X±(X/5) μm, of X±(X/6) μm, or of X±(X/8) μm, where X is any of the values mentioned above for d₅₀, or a value in any of the listed ranges for d₅₀. The photoluminescent material may also have a d₉₀ smaller than or equal to 3× or 2.5×μm.

In some cases, a photoluminescent powder may be coated with a protective coating—e.g. a hydrophobic coating to protect it against hydrolysis or other reactions, for example when exposed to water. The coating may be thin compared to particle size, and may be included in the particle size measurements described herein (were present).

The method may be arranged such that the formation of the photoluminescent layer is complete within 36 hours, and optionally within 24 hours, or within 12 hours, of a first printing of the ink onto the substrate.

The ink may comprise at least 5% by mass of a retarder, e.g. a glycerine-based retarder. The retarder may be lost from the layer on drying/baking.

The method may further comprise, after finishing printing (e.g. after printing the final layer in a multi-layer printing process) of the ink, baking the substrate and printed material at a temperature of at least 100° C., and optionally of 145° C. or 160° C. The baking may include a dwell period at the selected (maximum) temperature of between two minutes and two hours, optionally between 10 minutes and one hour or between 15 and 30 minutes, and further optionally of 20 minutes.

Multiple layers of ink with a loading of at least 20% or 30% photoluminescent material by mass may be deposited onto the substrate. The method may comprise drying each layer before the next layer is applied. The drying may be performed for a period of less than 20 minutes, and optionally less than ten minutes, per layer. In embodiments in which both baking and drying is performed, the drying may be performed at a lower temperature than the baking.

The method may further comprise inserting the photoluminescent layer into a housing. Such a housing may protect the photoluminescent layer in use. The housing may comprise a polymeric cover arranged to cover the layer of photoluminescent material.

In some implementations, the method may further comprise attaching a polymeric cover to the substrate, the cover being arranged to protect the photoluminescent layer in use. The substrate and the cover may together form a housing for the photoluminescent layer.

In either scenario—whether the substrate is placed within a housing or forms part of a housing—the polymeric cover may comprise:
at least 20% recycled polymer by mass; and
a biodegradable additive.

In such embodiments, the cover therefore both includes recycled material, and is itself biodegradable so reducing periods in landfill at end-of-life. Such a cover may comprise 50±10% or 50±5% virgin polymer by mass and 50±10% or 50±5% recycled polymer by mass, the virgin and recycled polymers optionally being of the same type—e.g. polycarbonates. The loading of the biodegradable additive may be between 0.01% and 0.2% of the mass of the cover, optionally between 0.01% and 0.10% of the mass of the cover, and further optionally may be 0.05% by mass of the cover. The loading of the biodegradable additive may be 0.05±0.0025% by mass of the cover.

The ink may have a viscosity in the range from 200 Pa·s to 400 Pa·s, and optionally between 300 Pa·s and 350 Pa·s. This viscosity may be the dynamic viscosity of the ink, measured using a vertical falling ball viscometer.

The resin used to make the ink may be transparent or translucent. Prior to the combination of the photoluminescent material therewith, resin of the thickness intended for use in the PL layer may have a total light transmittance of at least 85% or 90%, and optionally at least 95%, of incident light. This transmittance may apply across the whole visible light spectrum, or, in other embodiments, at least in the wavelength ranges of (i) the light desired for charging the PL material, and (ii) the light emitted by the PL material.

The resin may comprise at least 5%, 7%, or 10% of an acrylic co-polymer by mass of the resin, and optionally may comprise between 5% and 60% acrylic co-polymer by mass of the resin, and further optionally between 5% and 30%.

The ink may comprise a thinning agent. The thinning agent may be used to reduce the viscosity of the resin, facilitating flow. The thinning agent may also act as an emulsifier, e.g. stabilizing a suspension of an acrylic in water. The thinning agent may be selected to have a flashpoint of at least 40° C., and optionally of at least 45° C., 50° C., 55° C., 60° C., 65° C., 70° C., 75° C. or 80° C. The thinning agent may be or comprise one or more of glycerine, or a glycol ether such as diethylene glycol and/or propylene glycol. It will be appreciated that, for some substances, the same substance may act as both a thinning agent (reducing viscosity) and as a retarder (slowing drying/curing of the ink in the screen (for screen-printing), or on the pad or reel or other printing tool as applicable in other printing processes), or could act as both a thinning agent and a wetting agent, for example. However, other substances may only perform one role or the other.

The ink may comprise at least 1.2%, 1.5%, or 2% of the thinning agent by mass of the resin, and optionally at least 2.5% of the thinning agent by mass of the resin.

According to a second aspect of the invention, there is provided an aircraft emergency guidance assembly arranged to be mounted in an aircraft cabin, the assembly comprising:
a longitudinally extending photoluminescent layer;
a substrate supporting the photoluminescent layer; and
a housing arranged to protect the photoluminescent layer,
and wherein the photoluminescent layer is made from a water-based resin having embedded therein a photoluminescent material optionally having an average particle size, d₅₀, in the range from 10 μm to 100 μm, and optionally from 15 μm to 50 μm.

The photoluminescent layer may comprise at least 20% or 25% photoluminescent material by mass, the photoluminescent material being embedded within the set resin. The photoluminescent layer may comprise at least 30%, 35%, 40%, 45%, 50%, or 55% photoluminescent material by mass, and may comprise 55-75% or 65-70% photoluminescent material by mass.

The aircraft emergency guidance assembly may be made by the method of the first aspect.

The substrate may be a polymeric substrate.

The substrate may comprise at least 50% recycled material.

The photoluminescent layer may have a thickness in the range from 200 to 450 μm, from 200 to 360 μm or from 300 μm to 400 μm, or from 300 to 350 μm. The photoluminescent layer may have a thickness of around 350 μm or of around 375 μm.

The photoluminescent material may have a d₅₀ (median particle size) of X μm, and a d₉₀ of less than or equal to 3X μm.

The photoluminescent layer may be formed from at least two individually deposited and dried layers. The plurality of layers together may build up a total thickness of the photoluminescent layer. The photoluminescent layer may comprise five, six, seven, or eight such layers.

The longitudinally extending photoluminescent layer and substrate may be slidably insertable into, and/or removable from, the housing together.

The housing may be polymeric, and may comprises at least 20%, 30% or 50% recycled polymer by mass. The recycled polymer may be recycled polycarbonate. The recycled polymer may be colorless, and optionally may be a colorless polycarbonate.

The housing may be polymeric and may comprise a biodegradable additive arranged to allow or facilitate biodegradation of the polymer. The loading of the biodegradable additive may be 0.05% by mass of the housing. The biodegradable additive may cause some frosting or clouding of the housing. In a part of the housing covering the photoluminescent material, a minimum light transmission threshold may be set, and the loading may be controlled so as to not cause the light transmission to drop below that threshold. The biodegradable additive may be or comprise a carbohydrate-based or starch-based additive (in additional or alternative embodiments, pro-oxidation additives and/or bioaugmentation additives may also be used, as discussed in more detail in the applicant's UK patent application GB 2403007.4 entitled “SUSTAINABLE AIRCRAFT FLOORPATH MARKING”, which is incorporated herein by reference). The biodegradable additive may be or comprise BioSphere 201 grade biodegradable additive, and optionally may be the BioSphere 201J biodegradable additive.

In embodiments using both recycled polymers and a biodegradable additive, the frosting may be beneficial in hiding aesthetic defects caused by the use of the recycled material.

A surface roughness of the upper surface (or presentation surface) of the photoluminescent layer may be greater than 35 μm, and optionally around 45 μm. The roughness may be similar to P320 grit size sandpaper.

The upper surface (or presentation surface) of the photoluminescent layer may have a gloss of less than 1 GU for an 85° measurement, optionally of less than 0.5 GU, and optionally around 0.1 GU.

The upper surface of the photoluminescent layer may therefore be rougher, and/or less glossy, than typical for prior art photoluminescent layers.

According to a third aspect of the invention, there is provided an aircraft having an aircraft cabin comprising an aircraft emergency guidance assembly in accordance with the second aspect.

The aircraft cabin may comprise a plurality of such emergency guidance assemblies connected together.

The plurality of such emergency guidance assemblies connected together may be used to form a track arranged to guide a person from a seat to an emergency exit.

The aircraft emergency guidance assembly may be arranged to be mounted on a floor of the aircraft cabin.

The aircraft cabin may comprise at least one track extending along an aisle of the aircraft cabin, the track comprising a plurality of emergency guidance assemblies as described with respect to the first aspect connected together.

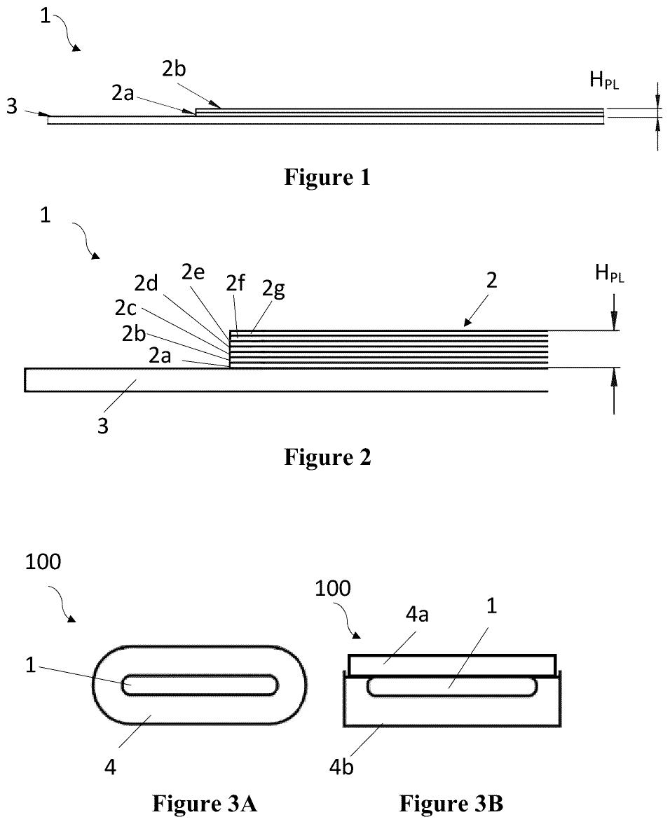

FIG. 1 of the appended drawings illustrates a cross-section of a component 1 of an aircraft emergency guidance assembly 100 in accordance with various aspects of the invention. The component 1 comprises a photoluminescent layer 2 and a substrate 3 on which the photoluminescent (PL) layer 2 is provided. The component 1 is generally arranged to form an internal part of the aircraft emergency guidance assembly 100 in use, and therefore may be referred to as an insert 1.

The resultant aircraft emergency guidance assembly 100, of which two examples are shown in cross-section in FIGS. 3A and 3B, is adapted to be mounted in an aircraft cabin. The assembly 100 comprises a longitudinally extending layer 2 of photoluminescent material and a housing 4 surrounding and protecting the photoluminescent material 2. In some embodiments, the substrate 3 may form a part of the housing 4—this may be seen as the PL material 2 being deposited directly onto a part of the housing 4. In other embodiments, the substrate 3 may be placed within the housing 4.

Turning back to FIG. 1, the insert 1 comprises a substrate 3. The substrate 3 is arranged to act as a support for the PL material 2. In the embodiment being described, the substrate 3 is made of a polymer, and more specifically is polypropylene. Any suitable polymer—e.g. an aerospace regulation-compliant polyurethane or polycarbonate—may be used instead. In the embodiment being described, the substrate 3 is made of recycled polypropylene, so reducing the need for virgin polymers and increasing sustainability. A polypropylene sheet or strip including 20% to 80%, and optionally 80%, recycled polypropylene is used for the substrate 3 in the embodiment being described. In various embodiments with polymeric substrates 3, the substrate 3 may comprise at least 50% recycled polymer by mass, and optionally also a biodegradable additive as described in more detail below.

In alternative embodiments, a paper-based substrate 3 may be used instead, the paper-based substrate 3 preferably having a weight of at least 250 gsm. Such a substrate may comprise at least 50% recycled paper by mass.

The insert 1 further comprises a layer 2 of PL material 2 mounted on the substrate 3. In the embodiment being described, the PL layer 2 is formed by screen-printing of an ink onto the substrate 3. In the embodiments described below, screen-printing is the selected printing process. It will be appreciated that other printing processes may be used in other embodiments, and that the ink properties and composition may be adjusted as appropriate for the printing process.

In various embodiments, the PL layer 2 may be deposited directly onto the material making up the bulk of the substrate (e.g. a surface of the polypropylene), or onto an intervening layer, e.g. a coating provided on the substrate. Such a coating may be used to improve adhesion of the PL material, and/or to provide an even background of a desired colour (e.g. white). In embodiments in which a bulk material of the substrate 3 is at least partially transparent, such a layer may improve aesthetics of the insert 1 from below (i.e. from the opposite side of the substrate 3 from the PL layer 2, which is the lower surface in the orientation shown).

An embodiment using such a coating 5 is shown in FIG. 6. In this example, the substrate 3 is a 300 μm thick polypropylene layer, made with 80% recycled polypropylene. This substrate 3 is not transparent, or at least not fully transparent, and appears white. A layer 5 of MagnaPrint® AquaFlex White is then applied to the substrate 3, in this embodiment, by screen-printing—other inks, and/or other ink application methods, may be used in other embodiments to provide a coating 5, and in still further embodiments no such coating may be used. This coating 5 may be opaque and reflective, reflecting incident light from the PL luminescence forward and so improving optical performance of the apparatus 1. A PL layer 2 is then formed on top of the coating 5, in this embodiment by building up multiple layers of a water-based ink containing PL material. The PL material may be, for example, Sr₄Al₁₄O₂₅:Eu, Dy if a blue-glowing, product is desired (e.g. a PL material in Luminova®'s BGL range) or SrAl₂O₄:Eu, Dy if a green-glowing product is desired. It will be appreciated that any PL material which meets the requirements for use in aircraft safety signage may be used, and that these products and formulae are mentioned by way of non-limiting example only (for example, PL materials from Honeywell or another supplier may be used in place of those from Luminova®). The total height, H, of the product 1 is around 0.75 mm, and more specifically may be 0.75±0.05 mm, including the substrate 3, coating 5, and PL layer 2. In other embodiments, the total height, H, of the product 1 may be in the range from 0.3 mm to 5 mm.

FIG. 1 shows an embodiment with a PL layer 2 formed of two layers 2a, 2b of the ink. FIG. 2 shows an embodiment with a PL layer 2 formed of seven layers 2a, 2b, 2c, 2d, 2e, 2f, 2g of the ink. It will be appreciated that different numbers of ink layers may be used in other embodiments. In various embodiments, the PL layer 2 may be formed from a single-layer deposition of ink or from multiple layers of ink, for example from one to ten layers, and optionally three, four, five, six, seven, or eight layers.

In the embodiments of FIGS. 1 and 2, the same ink is used to make each layer 2a-2g. In other embodiments, different inks may be used for different layers.

In some embodiments, multiple ink layers 2a, 2b, 2c, . . . , 2n, and optionally all ink layers of the final PL layer 2, may be applied sequentially, without moving or cleaning the screen of the screen-printer between layer applications. Applying multiple layers without cleaning the screen may improve time efficiency and reduce ink wastage, but increases the likelihood of ink drying on the screen. If the screen is not moved and the substrate 3 kept in the same position (e.g. being dried in situ when the screen is raised, or being placed back in the same position), small dimples in the layer applied (e.g. due to screen imperfections or dry ink) may be in the same place in subsequent layers, so causing a larger irregularity in the finished PL layer. Rotation of the screen and/or substrate between layer applications may be implemented between applications to minimize this effect. Additionally or alternatively, cleaning of the screen between applications (for example, between each layer application, or less frequently, e.g. applying three ink layers, then cleaning the screen, and then applying an additional four layers) may be performed to avoid this potential defect propagation. A balance may be struck between surface property tolerances and process efficiency. It will be appreciated that the same principles can be applied for pad printing or reel-to-reel printing, for example—a pad or reel may be re-aligned and/or cleaned between applications of the ink as desired.

In the embodiments being described, the height of the PL layer 2, HPL, including all ink layers that form it, is in the range from 200 to 500 μm, and optionally from 250 to 450 μm, and more specifically around 350 to 400 μm. The PL layer thickness is 375 μm in some embodiments. The total height of the insert 1, including the substrate 3, is in the range from 500 μm (0.5 mm) to 3 mm, and more specifically around 1.5 mm, in various embodiments.

In various embodiments, each ink layer forms a portion of the PL layer 2 with a thickness of around 50 μm. It will be appreciated that a thinner, more fluid, ink generally forms thinner layers than a thicker, more viscous, ink, assuming other conditions are equivalent. The ink used is a water-based resin with a PL pigment suspended therein (and optionally one or more additives); the resin can be thinned to a desired consistency by adding more water, to improve its printing performance and/or adjust layer thickness.

In the embodiments being described, the PL material for use in the ink is provided as a ceramic powder, with an average particle size, d₅₀, of 40±5 μm in some embodiments, and 25±4 μm in other embodiments. The PL material may be, for example, SrAl₂O₄:Eu, Dy, or Sr₄Al₁₄O₂₅:Eu, Dy, although it will be appreciated that any PL material with suitable luminance and glow colour for use in aircraft emergency guidance may be used.

PL materials tested include those listed in Table 1, below, all provided by Luminova®:

TABLE 1
PL materials

| | | | | Hydrophobic |
|---|---|---|---|---|
| Formula | PL glow colour | d50 | d90 | coating? |
| SrAl₂O₄:Eu, Dy | Yellow-green | 25 ± 4 μm | ≤60 μm | Yes |
| SrAl₂O₄:Eu, Dy | Green | 40 ± 5 μm | ≤115 μm | Yes |
| Sr₄Al₁₄O₂₅:Eu, Dy | Blue-green | 25 ± 4 μm | ≤60 μm | No |
| Sr₄Al₁₄O₂₅:Eu, Dy | Blue-green | 40 ± 5 μm | ≤115 μm | No |

The d₅₀ and d₉₀ values in Table 1 include the coating, where present (for the green- and yellow-green-emitting pigments). The blue-emitting pigments are not coated with a hydrophobic coating as the structure is different, and it is not attacked by water in the same way.

In some embodiments, a retarder (e.g. a glycerine-based retarder) is also added to the ink, to slow drying of the ink—this may assist in avoiding drying of the ink whilst still on a screen to be used for screen-printing.

Various commercially-available water-based resins were tested for use in the inks. The resins were mixed with the photoluminescent material to form an ink with 35% by mass resin and 60% by mass PL material, with the remaining 5% being a glycerol retarder. Variations were tested, with the most successful being 30-40% resin by mass, and 50-60% PL material by mass in the wet ink (it will be appreciated that loss of water, and potentially if any volatile additives, during drying will increase the % mass loading of the PL material in the final layer 2).

Even with the use of a retarder, some of the resins were found to dry on the screen within 5-10 minutes, making printing difficult. The commercially-available resins selected for further testing were narrowed down to MagnaPrint ND Base, MagnaPrint Glass Beads Reflective Clear, MagnaPrint AquaFlex V2, and Art2SilkScreen Water Based Resin. It will be appreciated that these are listed by way of non-limiting example only, and that any suitable water-based resin with similar properties may be used instead in other implementations.

In addition, it will be appreciated that resins which were found to dry too quickly for the process used in the specific method described below may be suitable for use in implementations with shorter on-screen periods for the ink, and/or may be usable with additional retarder. Water-based resins such as Permaprint Premium Clear, Apollo Ink S34036, and Colegraf Water-Based Clear Varnish which were tested and found to dry “too quickly” may therefore still be used in other embodiments of the invention.

The samples prepared using these inks were charged for 20 minutes by exposure to light at 250 Lux, and left to discharge for an hour, upon which the PL luminescence performance was measured (table 2). All resins tested produced similar results (within a 10% margin), including the resin containing glass beads which were suggested to improve light scattering (this did not appear to be beneficial). The results are shown in Table 2, below.

TABLE 2
Luminance of test samples after charging and a one-hour discharge (mcd/m²)

| | MagnaPrint | MagnaPrint Glass | MagnaPrint | Art2SilkScreen |
|---|---|---|---|---|
| Resin | ND Base | Beads Reflective Clear | AquaFlex V2 | Water-Based Resin |
| Luminance | 32.560 | 33.172 | 33.056 | 33.541 |

The water-based resins generally comprise a suspension of one or more polymers in water-acrylic co-polymers are often used. The ratio of water to the polymeric component(s) affects the viscosity of the resin, with higher water-content resins being thinner/less viscous. For example, the resin may be 20-75% polymeric components by mass of the resin, and optionally may be at least 50% polymeric components by mass. The resin may be 8-60% water, optionally 10-18% or 11-15% water, and further optionally may be around 13% water, by mass of the resin (the commercial resin acquired may be diluted with additional water in making the ink described herein, so increasing the % water of the resin—the water-based resin of the ink may therefore have a higher percentage water than the commercial resin from which it is made. It will be appreciated that the minimum of 20% water-based resin by mass of the ink includes any water added to thin the commercial resin). In addition to water and the polymeric component(s), the resin may comprise one or more additives, such as one or more emulsifiers (used to make the suspension more stable), thinning agents (to reduce viscosity), wetting agents (to improve surface coverage on printing, e.g. butyl acetate), and/or retarders (to slow drying/curing). A single additive may perform two or more of those roles in some embodiments—for example a glycol either may act as emulsifier, thinning agent, and retarder. In general, each additive may be no more than 10% of the ink by mass, and optionally no more than 5% or 2.5% of the ink by mass.

The Magnaprint Aquaflex V2 water-based resin was selected for the tests described below.

Paper-based substrates 3 were tested with the ink, with coated papers being avoided due to coatings potentially melting during a curing process of the ink (described below). It was found that the (uncoated) paper stocks below 250 gsm were too thin to prevent the water-based resin from seeping through, and the substrate 3 warped. Paper with a weight of 255 gsm was chosen as it was thick enough to withstand the printing process without warping, but thin enough to fit through the cavity of a standard track/housing 4 (as described in more detail below)—it will be appreciated that minimizing weight is generally favored in aerospace applications.

Polymeric substrates 3, such as polypropylene sheets (some including 80% recycled polypropylene, that polypropylene optionally being post-consumer recycled) and polybutylene terephthalate sheets were also successfully tested.

For post-consumer recycled (PCR) polymer sheets, it is impractical to trace the polymer down to its original component parts; as it is known that the recycled material is polypropylene (in this instance), but not the precise types and origins of the polypropylene. The sheet manufacturer assigns a batch number to each final sheet and traceability (to meet aerospace requirements) is provided in the form of a certificate of conformity. This certificate must be provided for each batch and is an assurance that the material delivered corresponds to the batch number, is manufactured to the correct dimensions, and contains the stated percentage of PCR material (e.g. 80%). Further conformity testing may be performed in house to ensure the PCR sheets are fit for purpose for the printing, and the final printed assemblies 1 may undergo a first article inspection against set internal standards. In this way, post-consumer recycled materials may be used without violating stringent aerospace traceability requirements.

The ink compositions shown below in Table 3, using Magnaprint Aquaflex V2 Water Based Resin as the commercial resin, were all tested, on various substrates and with between four and seven printed ink layers to form the PL layer 2.

The commercial resin itself was found to be around 13% water by mass, such that an ink comprising 35% commercial resin by mass and no additional water would be around 4.6% water by mass, and an ink comprising 26% commercial resin by mass and 13% added water would be 16.4% water by mass. The resin was found to be fully miscible with the added water (where used), so evenly diluting the commercial resin to form a less viscous water-based resin.

TABLE 3
Ink compositions

| | Loading/Composition by % mass of ink | | | | | |
|---|---|---|---|---|---|---|
| Component | Ink A | Ink B | Ink C | Ink D | Ink E | Ink F |
| PL material | 60% | 60% | 60% | 60% | 52% | 50% |
| Commercial Resin | 35% | 30% | 30% | 30% | 26% | 25% |
| Retarder | 5% | 10% | 3% | 5% | 9% | 8% |
| Added water | 0% | 0% | 7% | 5% | 13% | 17% |

Whilst Ink A was functional, it was thick and quick to dry on the printing screen, so the use of added water and/or more retarder was investigated. Ink B, replacing a portion of the resin of Ink A's composition with retarder, was still too thick for even printing, with the screen not being fully flooded. Substituting most of the retarder for water (Ink C) resulted in an ink which flooded the screen well, but dried in the screen too quickly for use with the desired printing method. The amounts of water and retarder were adjusted to equal masses for Ink D, but this was not sufficient to completely overcome this issue, with the ink still drying too quickly. Different balances of retarder and water were therefore tested in Inks E and F, with the composition of Ink E being found superior in terms of properties following the curing process (both inks printed well, on the selected substrate of a polybutylene terephthalate sheet).

For the testing of Ink E, for example, polybutylene terephthalate sheets were used to provide the substrate 3. Six sheets were printed with four layers of Ink E, two sheets with five layers of Ink E, two sheets with six layers of Ink E, and ten sheets with seven layers of Ink E (with each of two different PL materials in the ink).

Between layer depositions, each newly-added layer is dried. Once all desired layers have been deposited, the completed PL layer 2 is baked, and then fully dried. In other implementations, the resin may be UV-curable, and the layer may be cured with UV light rather than being baked and dried.

For the tests being described, the ink remained spread across the screen-printing screen for at least an hour, and typically several hours; whilst the printing of a single layer was found to take about 15-20 seconds, the screen was kept wet with the ink until all desired layers had been printed on all substrates 3 to be printed. This reduces ink wastage and cleaning requirements as compared to cleaning the screen between each layer application, but it will be appreciated that the use of retarder could be reduced if the ink were kept on the screen for a shorter time—this may be done in other implementations. Ink E showed no breakdown of the screen emulsion even when the ink was left on the screen for several hours, so facilitating this printing process.

In the tests being described, after each layer deposition, the resultant product was placed in a drying tunnel for a period of around two minutes-air around the deposited material, circulated within the tunnel by means of a fan or negative pressure extraction system, reaches temperatures of around 100° C. A conveyer was used to move the product through the tunnel over a period of around two minutes in these tests, although it will be appreciated that any suitable drying process may be used in other embodiments. More specifically, in the tests being described the temperature was 100° C. at the heating elements, and closer to 90° C. at the sheet (substrate and printed material). The drying temperature was kept low enough to not melt or deform the substrate 3. The drying process is used to render the deposited ink layer touch-dry, and so suitable for the printing of a further layer (and for moving, e.g. tilting, without the ink flowing), but some water and/or retarder (and optionally other additives) may still be present. After the final ink layer was dried, the completed insert 1 was then baked, following the data sheet recommendations of the commercial resin used (in this case, a baking process with a 20 minute dwell-time at 160° C., in air) and the resultant PL layer 2 was then left to cool and dry. This higher-temperature baking may serve to remove some or all of the remaining liquid within the PL layer 2. It will be appreciated that the temperature ramp-up and ramp-down periods of the baking process may be significantly longer than the dwell time at the maximum temperature, so providing an elevated temperature over a longer period, assisting with evaporation. In the tests being described, the total time period in the oven was one hour and fifteen minutes, of which twenty minutes was the dwell-time at the maximum temperature. The baking process in these tests is simply a longer and higher-temperature drying process to eliminate more moisture from the layer.

The inserts 1 printed with four ink layers had a thickness of 200 μm on average, for five ink layers, the average thickness was 250 μm, for six ink layers, the average thickness was 300 μm, and for seven ink layers, the average thickness was 350 μm, demonstrating a typical single-layer thickness of around 50 μm.

A thickness of around 375 μm±50 μm may be favoured for the PL layer 2.

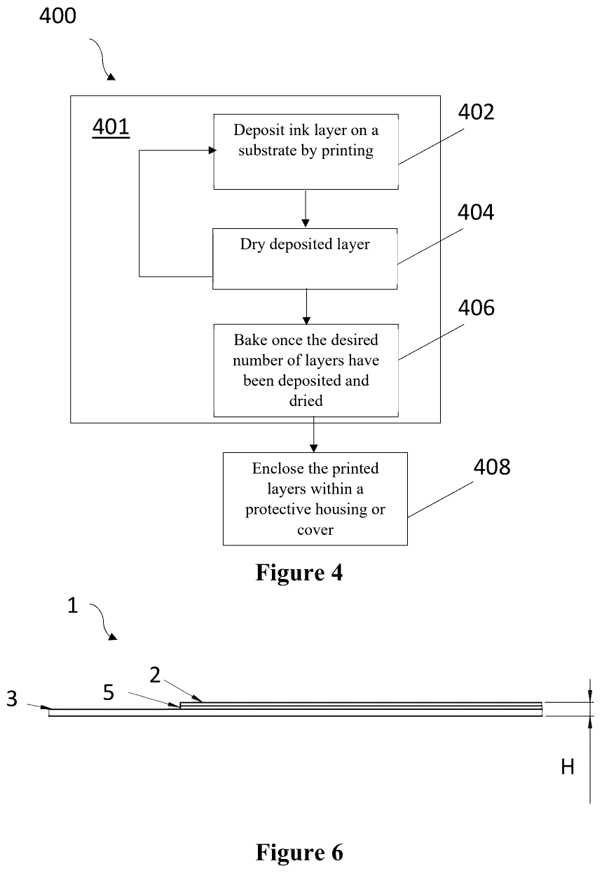

FIG. 4 illustrates a method 400 of manufacturing an aircraft emergency guidance assembly 100 in a more generalized form.

The method 400 comprises forming 401 a photoluminescent layer 2 on a substrate 3 by printing an ink onto the substrate 3. The method 400 may comprise forming 401 the photoluminescent layer 2 on the substrate 3 by screen-printing the ink onto the substrate 3.

The process of forming 401 the PL layer 2 comprises acquiring a suitable ink to form the PL layer 2. As described above, such an ink comprises:
a water-based resin, wherein the water-based resin forms at least 20%, and optionally at least 25%, of the ink by mass; and
a photoluminescent material, wherein the photoluminescent material forms at least 20% of the ink by mass.

In general, at least 30%, 40%, 45%, or 50%, and optionally around 60%, of the ink by mass is the photoluminescent material.

Different loadings of the PL material may be suitable for different aircraft emergency guidance assemblies 100. For example, in embodiments in which the upper/presentation surface of the PL layer 2 is arranged to be unobstructed in use (generally covered only by a transparent or highly translucent colorless protective layer), a loading of just 25%-35% of the PL material in the ink may give sufficient luminance to meet aerospace safety regulations. By contrast, in embodiments in which the PL layer 2 itself is to be printed on (e.g. to show a pattern or symbol, which may be opaque or translucent (e.g. partially transparent)), covered with a colored film or a film having printed thereon a pattern or symbol, or contained within a colored housing, or a housing having printed thereon a pattern or symbol, a higher loading of the PL material may be favored to ensure sufficient luminance—for example, a loading of 45-75% by mass of the ink, and optionally of 50-70%, may be used.

In general, at least 30%, and preferably at least 35%, of the ink by mass is the water-based resin, which may be a commercial resin used as-is, or with added water to thin it.

The remaining mass may be made up by a retarder and any other desired additives or pigments.

Due to loss of water and/or retarder from the PL layer 2 during the drying and baking process (which may be referred to as curing of the resin), the mass of the ready-for-use layer 2 is lower than that of the layer 2 when freshly printed. For example, an ink like Ink E with a 52% loading of PL pigment by mass may form a cured layer with a 66% loading of PL pigment by mass, due to the loss of the more volatile components.

The method 400 (and, more specifically, the forming 401 of the PL layer 2) comprises depositing 402 a layer of the ink onto a substrate 3, by screen-printing in this embodiment, and then drying 404 the deposited layer. These two steps 402, 404 are repeated until a desired number of layers has been built up—for example, twice, thrice, four times, seven times, or eight times. The number of layers desired may depend on the thickness of each individual ink layer, and hence on the viscosity of the ink. A total PL layer 2 thickness of around 375 μm may be desired.

The dynamic viscosity of the ink was measured using a vertical falling ball viscometer—in particular, the density of the ink, ρᵢₙₖ was calculated, and a graduated cylinder with diameter 30 mm was filled with the ink to a level of 2 cm from top of cylinder. Markers were applied to the cylinder 2 cm below the surface of the liquid and 2 cm from the bottom of the cylinder, and the distance between the two markers measured.

A metal ball of radius, r, 4.4 mm and density, Pball, 7778 kg/m³ was then positioned just above/touching the surface of the liquid and released, and the time taken for the ball to fall from the first mark to the second mark was recorded so allowing the average velocity of the ball bearing through the liquid between the markers, v, to be calculated.

The dynamic viscosity was then calculated using the following equation:

$$Viscosity = \frac{2 {gr}^{2} ( {ρ}_{ball} - {ρ}_{liquid} )}{9 v}$$

where g is the acceleration due to gravity.

The viscosity of Ink E, discussed above, was measured to be 333 Pa·s by this method (averaged over three measurements). More generally, inks may be made with viscosities of between 300 Pa·s and 400 Pa·s, and more specifically between 310 Pa·s and 350 Pa·s. It will be appreciated that viscosities may be adjusted as desired in various embodiments depending on the desired overall layer thickness, and/or desired number of screen depositions (or otherwise-printed individual ink layers) to form the layer.

In addition to measuring viscosity of the ink, light transmission of the resin was also tested before combining that with the PL material to form the ink. As a typical number of ink layers for tested products was seven, seven layers of the resin alone were therefore deposited on a clear polycarbonate substrate and exposed to 250 Lux light. Each layer of the resin alone was fond to have a thickness of around 10 μm, for a total thickness of around 70 μm. This is of course lower than the layer thickness for PL ink samples due to the absence of the PL material, but provides a measure of light blockage due to the resin itself—this thickness is representative of the total summed thicknesses of the resin itself in the final PL layer 2, around the PL material. The substrate was previously tested and found to let through 232 Lux of the 250 Lux incident light. With the application of the wet resin, this transmission dropped to 194 Lux. However, following the drying and curing process described below, this increased to 226 Lux—a drop of only 6 Lux (2%) more than that caused by the substrate. The resin may therefore be described as having a transmittance of around 98%, for the typical resin thickness used in the PL layer 2.

Once the final drying step 404 is complete, the PL layer 2 may then be baked 406, or otherwise cured. The conditions used generally depend on the resin used, with the substrate 3 generally being selected to be suitable for undergoing that treatment unchanged.

After curing, the final PL layer 2 may comprise at least 60% PL material by mass (and optionally at least 65% PL material by mass), and at least 30% cured resin by mass.

Surface measurements were taken of the cured PL layer 2.

A surface roughness of the upper surface (or presentation surface—i.e. the surface furthest from the substrate 3) of the photoluminescent layer 2 was judged to be around that of P320 grit size sandpaper (46.2±1.5 μm). By contrast, PL layers made with the same PL material but a traditional, organic solvent-based, resin were found to be smoother, having surface roughnesses closer to that of P500 grit size sandpaper (30.2±1.5 μm). It will be appreciated that the precise roughness will depend at least in part on particle size distribution of the PL material used to make the ink, but that, for the same PL material, the water-based ink as described herein was found to provide a rougher surface finish than the organic solvent-based inks used previously.

Correspondingly, the upper surface of the photoluminescent layer 2 was measured to be less glossy compared to a counterpart made with a traditional, organic solvent-based, resin. The gloss was measured, at an 85° angle, to be around 0.1 Gloss Units (GU), as compared to 1.4 GU measurements for the organic solvent-based counterpart using the same PL material.

The inventors appreciated that smoothness (and thereby also gloss) could be increased by slowing the drying process, e.g. by drying each ink layer, or at least the uppermost ink layer, at a lower temperature over a longer time, so allowing for more settling and sinking of the PL material within the ink. However, the higher roughness and lower gloss were deemed not to provide a significant disadvantage in testing, so the faster production rate of the quicker drying was favored.

The cured component 1 is then enclosed 408 within a protective housing 4, or a cover 4a may be connected 408 to the substrate 3, so covering the PL layer 2 (the substrate may be thought of forming part of a protective housing in such embodiments).

To complete the aircraft emergency guidance assembly 100, the photoluminescent (PL) layer 2 and the substrate 3, which may be referred to collectively as the “insert”, of some embodiments may therefore be inserted into a housing 4. The housing 4 is arranged to surround and protect the PL layer 2. A portion of the housing 4 covers the PL layer 2 and may be referred to as a cover 4a. The housing 4 may be made of a polymeric material, such as polycarbonate, and at least the cover 4a is arranged to be translucent, if not transparent, to allow light transmission.

To be used in an aerospace setting, all component parts must have full traceability of the raw material. Due to the mixed nature of recycled materials, it is not usually possible to trace the composition. In order to meet the aerospace industry's requirements on material traceability, the recycled polycarbonate (or other polymer) of the housing 4 is product manufacturing offcut/excess (industrial waste that would normally be disposed of/go to landfill) as opposed to post-consumer waste; batch numbering and recording of the recycled polymer can therefore be implemented, with each batch of re-chipped material being assigned its own part and batch numbers. Due to the nature of the re-chipped material, it is often not possible to determine its exact makeup. However, all the possible grades of polycarbonate (or other polymer, as appropriate) that might be included can be noted for each batch, and the grade with the weakest performance against a given aerospace requirement may be used as the limiting case for testing. For example, in a batch of recycled polycarbonates, Calibre 6303/3 grade may be the least flame-retardant polycarbonate likely to be included in the re-chipped material. Therefore, a sample with 50% Makrolon® 6717 and 50% Calibre 6303/3 re-chipped polymer may be used as the test sample for flammability requirements. A different sample may be used for testing of another characteristic for which the Calibre 6303/3 grade is not weakest. The approach described herein therefore allows an aircraft emergency guidance assembly 100 including recycled materials to be made with full traceability. In particular, recycled polymers may be used in the substrate 3 and/or housing 4.

In the embodiment shown in FIG. 3A, the housing 4 is a single-piece housing 4, with the cover 4a being integral with the rest of the housing 4—the housing 4 effectively forms a sleeve surrounding the insert 1. The entirety of the housing 4 is generally made of the same material in such embodiments. In other embodiments, such as that shown in FIG. 3B, the housing 4 comprises multiple parts, for example two separable parts:
(i) the cover 4a arranged to lie above the PL layer 2; and
(ii) a base 4b arranged to lie below the PL layer 2 (in some embodiments, this base 4b may be provided by the substrate 3).

It will be appreciated that “above” and “below” are defined here with respect to a typical orientation of a floorpath marking in use, where the upper face of the guidance assembly 100 is the face intended to be seen by users. The cover 4a may therefore be described as providing a presentation surface, irrespective of orientation, with the base 4b lying on the far side of the PL layer 2 from the cover 4a, and optionally joining the cover 4a at the edges of the PL layer 2.

In the second embodiment, shown in FIG. 3B, the sides of the PL layer 2 are enclosed by portions of the base 4b. In other embodiments, the cover 4a may curve down to protect the sides, and/or separate side pieces of the housing 4 may be provided. In still other embodiments, the cover 4a itself may be split into multiple pieces. In still other embodiments, the substrate 3 itself may form a part of the housing 4 for the PL layer 2. For example, the substrate 3 may extend beyond the PL layer 2, and may have a cover 4a connected thereto. The substrate may take the place of a base 4b of the housing 4.

In embodiments with a housing 4 comprising multiple parts, one or more of the parts may be made from different materials. For example, in some embodiments, the percentage of recycled polymer, and/or the loading of the biodegradable additive, may be higher in the substrate 3 and/or base 4b (and optionally in any side pieces) than in the cover 4a. For example, one or more parts of the housing 4 other than the cover 4a may comprise at least 50%, 55%, 60%, 65%, 70%, or 75% recycled polymer by mass, and may optionally be 80% or even 100% recycled polymer (i.e. entirely recycled polymer, except for small percentages of any additives). The optical property requirements are generally more stringent for the cover 4a than for the base 4b (and any side pieces of the housing 4), so allowing use of a less clear material for the base.

A loading of a biodegradable additive in the base 4b and/or substrate 3 (and optionally in any side pieces of the housing 4) may be much higher than that in the cover 4a, for example by a factor of ten, twenty, or fifty. For example, the loading of the biodegradable additive in the base 4b may be around 1%, 1.5%, 2%, or 2.5% by mass of the polymeric part 4b.

In the cover 4a, the loading of the biodegradable additive is generally kept lower to ensure sufficient clarity/minimal light-blocking of the cover material, so allowing the PL layer 2 to be charged by incident light unimpeded, and allowing the PL glow of the material 2 to travel through the cover 4a unimpeded. In particular, in various embodiments, light transmission through the polymeric cover 4a is at least 80%, and optionally at least 85%, of incident light (which may be daylight spectrum light).

In the examples described above, the selected biodegradable additive is a BioSphere 201 grade biodegradable additive, and more specifically is the BioSphere 201J biodegradable additive. In other implementations, a different biodegradable additive may be used, for example one or more of the products available from EcoPure®. It will be appreciated that the choice of additive may depend on the particular polymer(s) of the housing 4, among other factors, and that any suitable additive may be used provided that compliance with the applicable aerospace requirements is ensured.

The loading of the biodegradable additive in the housing 4, or at least in the cover 4a, is 0.05% by mass in some embodiments, and may be 0.05±0.0025% biodegradable additive by mass. In other embodiments, a loading of at least 0.02% and not more than 0.20%, and optionally not more than 0.12%, may be used, the loading optionally being in the range from 0.03% to 0.10% or from 0.04% to 0.09%. A trade-off between biodegradation rate and light transmission of the material may be considered in setting the loading. A higher loading of the biodegradable additive (or “bio-additive”, for brevity) may be possible for the same light transmission when the percentage of virgin polymer is higher (as the polymeric material itself may be clearer, so allowing for more clouding due to the additive whilst still meeting optical performance targets). The partial blocking of light due to the bio-additive advantageously also provides some frosting which may disguise cosmetic imperfections due to the use of recycled material.

It will be appreciated that the base of the assembly 100—i.e. the underside of the housing 4 in the embodiment shown in FIGS. 3A and 3B—may be adapted to be securable to the floor of an aircraft cabin 20 in use. The base of the assembly 100 may be secured to, or mounted on, the floor by any suitable conventional means.

In embodiments in which the aircraft emergency guidance assembly 100 is used as a floorpath marking, an underside of the housing 4 (e.g. the base 4b, or the substrate 3) is therefore arranged to be secured to the floor of an aircraft cabin 20. Light transmission through the base 4b or substrate 3 may therefore be irrelevant—a cloudy, or even opaque, material may therefore be used for the base 4b when the base 4b is a separate part from the cover 4a (albeit generally firmly fastened thereto, either directly or via intervening side portions of the housing 4), and for the substrate 3. Even in embodiments in which the base and cover are integrally formed to make a one-piece housing, material composition may vary between the base and the cover, e.g. by careful co-extrusion of two or more materials, or by any suitable technique known in the art.

In many embodiments, the assembly 100 is generally adapted to be connected to a further assembly 100 to form an elongate track adapted to be fitted to the floor of an aircraft cabin 20 and to extend along an aisle 21 of the aircraft cabin towards an emergency exit.

In various embodiments, a lower surface of the housing 4 (e.g. a side of the base 4b furthest from the cover 4a in multi-part housings, or an underside of the substrate 3) has an image or pattern printed thereon, for example to label the product name, type, size, batch number, and/or other details. The base 4b/lower part of a single-piece housing 4/substrate 3 may be made partially or entirely opaque by such printing in some such embodiments. In particular in embodiments in which the housing 4 is a single piece, the entire surface of the housing 4 may therefore be arranged to be suitable for use as a printing substrate.

In some embodiments, especially in embodiments with sleeve-type housings 4, the longitudinally extending layer of photoluminescent material 2 (generally together with its substrate 3) is slidably removable from the housing 4—the PL layer 2 and substrate 3 combination of such embodiments may also be slidably inserted when manufacturing the assembly 100, and may be described as an “insert”. The “insert” 1 and “sleeve” 4 may therefore be easily separated for recycling or re-use. It will be appreciated that one or both ends of the assembly 100 may be hermetically sealed in advance of use (optionally sealed shut, or sealed to an adjacent assembly so as to form a longer track, optionally with an adhesive—which may be cured—or with localized melting of the polymeric casing 4), and that any such sealed ends may be cut off before slidingly removing the insert 1.

In embodiments with other designs of housing 4, assembly and disassembly approaches may be varied—for example, a lid-type cover 4a may be lifted off a base 4b (optionally after dissolving or cutting through an adhesive or other join holding one part to the other) and the PL material 2 (optionally with its substrate 3) may be lifted out or tipped out once the housing 4 has been opened.

In various implementations, as noted above, the assembly 100 extends longitudinally (being elongate in shape) and may be adapted to be connected to a further assembly to form a track 26 that can be fitted to a floor of an aircraft cabin 20 and to extend along an aisle 21 of an aircraft cabin.

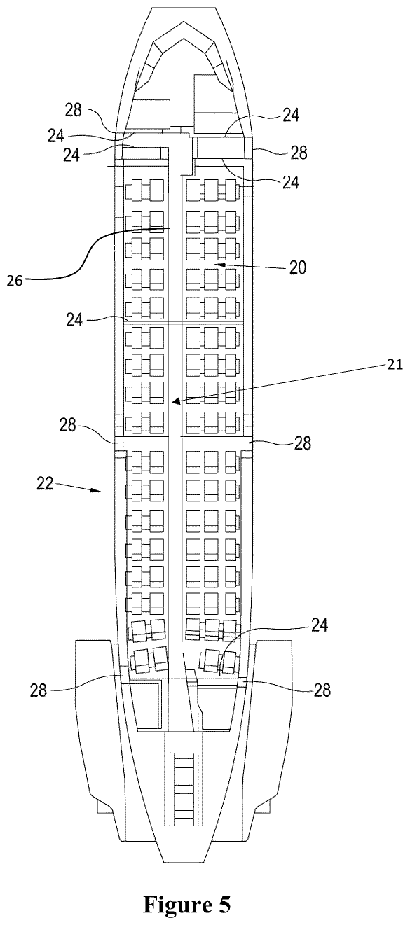

FIG. 5 is a schematic illustration of an aircraft 22 having an aircraft cabin 20 and a number of assemblies 1 connected together to form a track 26 extending along an aisle 21 of the cabin and arranged to guide a passenger from a seat to one or more emergency exits 28. The track 26 may guide passengers around or past one or more internal walls or dividers 24.

As illustrated in FIG. 5, it is intended that the assembly 100 will be utilized in a cabin 20 in an aircraft 22. The assembly 100 may be adapted to be secured to a floor in the cabin 20—for example along an aisle 22 and/or between rows of seats in exit rows.

It has been found that an assembly 100 in accordance with the invention is robust and durable. The rigorously-tested assembly 100 was found to meet all of the stringent performance requirements of an emergency exit way marker in an aircraft cabin even though various features—in particular, use of a water-based resin rather than the more traditional organic solvent-based resins, and, where present, the use of a biodegradable additive, the use of recycled material, and/or the use of mixed polymer materials to form the substrate and/or housing—go against long-held prejudices in the art.

It has been found that using materials as described herein reduces the use of organic solvents and enables the amount of virgin material that is required to be reduced significantly, and so reduces the environmental impact of the assembly. In addition, use of a biodegradable additive renders the polymer used for the substrate 3 and/or housing 4 biodegradable, so reducing the environmental impact at end-of-life of the assembly 100.

The upper surface 6 of the assembly 100 may be used to show one or more patterns or images, for aesthetic and/or safety reasons—e.g. one or more arrows indicating an exit direction, and/or a pattern to match or complement an aircraft carpet or other flooring may be provided. The housing 4 may therefore be used as a substrate which can be printed on to provide such patterns or images. Alternatively or additionally, an upper surface of the PL layer itself may be printed on to form a desired pattern or symbol (optionally with an opaque ink), and/or a film may be inserted between the PL layer and an underside of the cover 4a, and that film may be a colored or colorless film (provided that it is not opaque, at least not across its full area), and may be patterned or printed thereon.

The ink using a water-based resin as described herein was found to be suitable for deposition by printing, and the resultant assembly 1 was found to meet flammability requirements, luminance requirements (in particular, standards CS25 and CS23 for luminosity requirements), temperature range tolerances, and pressure range tolerances for aircraft cabin usage, whilst reducing the use of organic solvents, and so improving performance with respect to environmental requirement standards such as DO-160). As such, embodiments of the invention allow the sustainability of an aircraft emergency guidance assemblies to be improved whilst maintaining all of the required and desirable properties.

It will be appreciated that the embodiments described in detail herein are given by way of illustrative example only, and not intended to be limiting. The scope of the invention is to be limited only by the appended claims.

What is claimed is:

1. A method of manufacturing an aircraft emergency guidance assembly comprising forming a photoluminescent layer on a substrate by printing an ink onto the substrate, the ink comprising:
a water-based resin, wherein the water-based resin forms at least 20% of the ink by mass; and
a photoluminescent material having a median particle size, d50, in the range from 10 μm to 100 μm, wherein the photoluminescent material forms at least 20% of the ink by mass.

2. The method of claim 1, wherein the ink comprises at least 30% photoluminescent material by mass.

3. The method of claim 1, wherein the method is arranged to form a photoluminescent layer with a thickness in the range from 200 to 450 μm.

4. The method of claim 1, comprising printing a plurality of layers of the same ink onto the substrate so as to build up a resultant photoluminescent layer with a thickness in the range from 200 to 450 μm.

5. The method of claim 1, wherein the photoluminescent material has a d50 of between 15 μm and 50 μm.

6. The method of claim 1, wherein the photoluminescent material has a d90 of no more than three times the d50.

7. The method of claim 1, wherein the formation of the photoluminescent layer is complete within 36 hours, and optionally within 12 hours, of a first printing of the ink onto the substrate.

8. The method of claim 1, wherein the ink comprises at least 5% by mass of a glycerine-based retarder.

9. The method of claim 1, wherein the ink comprises at least 5% water by mass.

10. The method of claim 1, further comprising, after finishing printing of the ink, baking the substrate and printed material at a temperature of at least 100° C.

11. The method of claim 1, wherein multiple layers of ink with a loading of at least 20% photoluminescent material by mass are deposited onto the substrate, the method further comprising drying each layer before the next layer is applied.

12. An aircraft emergency guidance assembly arranged to be mounted in an aircraft cabin, wherein the assembly comprises:
a longitudinally extending photoluminescent layer;
a substrate supporting the photoluminescent layer; and
a housing arranged to protect the photoluminescent layer,
and wherein the photoluminescent layer is made from a water-based resin having
embedded therein a photoluminescent material having a median particle size, d50, in the range from 10 μm to 100 μm.

13. The aircraft emergency guidance assembly of claim 12, wherein the photoluminescent layer comprises at least 20% photoluminescent material by mass, the photoluminescent material being embedded within the set resin.

14. The aircraft emergency guidance assembly of claim 13, wherein the photoluminescent layer comprises at least 30% photoluminescent material by mass.

15. The aircraft emergency guidance assembly of claim 12, wherein the substrate is a polymeric substrate.

16. The aircraft emergency guidance assembly of claim 12, wherein the substrate comprises at least 50% recycled material.

17. The aircraft emergency guidance assembly of claim 12, wherein the photoluminescent layer is formed from at least two individually deposited and dried layers, the plurality of layers together building up the total thickness of the photoluminescent layer.

18. The aircraft emergency guidance assembly according to claim 12, wherein the longitudinally extending photoluminescent layer and substrate are slidably removable from the housing together.

19. The aircraft emergency guidance assembly according to claim 12, wherein the housing is polymeric and comprises at least 20% recycled polymer by mass.

20. An aircraft having an aircraft cabin comprising an aircraft emergency guidance assembly in accordance with claim 12.
